(19) United States
(12) Patent Application Publication
(10) Pub. No.: US 2021/0147063 A1
(43) Pub. Date: May 20, 2021

(54) FIREPROOF AND THERMAL INSULATOR PRODUCT

(71) Applicant: Airbus Operations S.L., Getafe (ES)

(72) Inventors: Manuel KEMPF, Getafe (ES); Asuncion BUTRAGUENO-MARTINEZ, Getafe (ES); Jorge BALLESTERO MÉNDEZ, Getafe (ES); Fernando INIESTA LOZANO, Getafe (ES); Guillermo HERNAIZ LOPEZ, Getafe (ES); Javier GUERRERO MARTÍN, Getafe (ES); Alberto ARANA HIDALGO, Getafe (ES); Jesus Javier VAZQUEZ CASTRO, Getafe (ES)

(21) Appl. No.: 17/096,108

(22) Filed: Nov. 12, 2020

(30) Foreign Application Priority Data
Nov. 14, 2019 (EP) 19383001.5

(51) Int. Cl. B64C 1/40; B32B 7/12; B32B 3/12; B32B 9/04

(52) U.S. Cl. CPC B64C 1/406; B32B 7/12; B32B 3/12; B32B 2262/101; B32B 2307/3065; B32B 2307/304; B32B 2605/18; B32B 9/045

(57) ABSTRACT

A fireproof and thermal insulator product which includes a honey-comb core infilled with Alkaline Earth Silicate material. The material of the honey-comb core can be metallic or polymeric. The product may further include a FRP layer, and/or a liquid barrier film, preferably being of thermoplastic material. An adhesive layer may be further deposited between the layer of honey-comb core infilled with AES and the layer of FRP.

### CROSS-REFERENCES TO RELATED APPLICATIONS

This application claims the benefit of the European patent application No. 19383001.5 filed on Nov. 14, 2019, the entire disclosures of which are incorporated herein by way of reference.

### FIELD OF THE INVENTION

This invention refers to a product that provides structures and associated systems with protection against the consequences of a fire event, particularly flame penetration, and that also provides thermal insulation capability. The invention is particularly applicable in different parts of aircraft and helicopters.

### BACKGROUND OF THE INVENTION

Many parts of the aircraft are subjected to fire events, and in order to ensure the normal operation of the aircraft, the structure and associated systems have to be protected against the fire event consequences.

For these purposes, several materials and solutions have been tested and installed to prevent the consequences of the fire events. Two main effects need to be solved depending on the application: flame penetration and thermal insulation.

The flame penetration issue needs to be addressed, keeping the fire enclosed in the designated area. On the other hand, the thermal insulation capability may allow the use of a wide range of materials for the structural applications having lower decoupling temperature requirements.

The most widely used state of the art solution are the thermal blankets, mainly made of ceramic or silicone laminates with an aluminum sheet. They are an effective solution for flame penetration and thermal insulation, but are also expensive and heavy.

Thermal blanket insulations may present some issues to be introduced in structural applications due to their lack of rigidity. Due to this, they could collapse during the manufacturing or assembly process, leading to a loss of their effectiveness.

Another state of the art solution is based on materials which work against a fire event by creating a porous charred layer of material, preventing the flame penetration and providing insulation. This option is relevant in many applications due to its performance, however structures submitted to vibrations cannot implement this solution due to the loss of protection under the operation conditions.

In a further state of the art solution, materials like titanium, steel or Inconel that exhibit higher fire-resistant/fire-proof capability are added or used instead of conventional materials usually used for structural parts such as aluminum, composite (CFRP, GFRP, etc.) in order to overcome the fire penetration issue. As example of this can be appreciated in the APU of an aircraft, which can be surrounded by a titanium firewall to prevent the aluminum (acting as structural material) from being damaged, and allowing the fire to come out of the tail cone in a fire event.

### SUMMARY OF THE INVENTION

An object of the present invention is to provide a product that is fireproof and has also good thermal insulation capability, which allows an avoidance of high temperatures at the structure around the fire source that could damage the structure.

The invention provides a fireproof and thermal insulator product that comprises a honey-comb core infilled with Alkaline Earth Silicate (AES) material.

The product works as a fire-proof and thermal insulation arrangement that can be served for structural and non-structural applications.

The invention provides the following advantages:
Lower cost than the state of the art solutions.
Low density material used in the infilled honey-comb core, allowing weight reduction and lighter solutions than the state of the art.
Fire-proof and thermal insulation capabilities ensured by testing.
Environmentally friendly.
Integration in structural panels with potential cost reduction, while avoiding the issue of collapsing the insulation material during the manufacturing and/or assembly process.
Enable the use of structural materials in fire-zone designated areas with limited high-temperature strength capability, due to the decoupling of thermal and structural requirements.

Other characteristics and advantages of the present invention will be clear from the following detailed description of several embodiments illustrative of its object in relation to the attached figures.

### BRIEF DESCRIPTION OF THE DRAWINGS

FIG. 1 shows a schematic view of a fireproof and thermal insulator product, according to a first preferred embodiment of the invention.

FIG. 2 shows a schematic view of a fireproof and thermal insulator product, according to a second preferred embodiment of the invention.

FIG. 3 shows a schematic view of a fireproof and thermal insulator product, according to a third preferred embodiment of the invention.

FIG. 4 shows a schematic view of a fireproof and thermal insulator product, according to a fourth preferred embodiment of the invention.

FIG. 5a shows an aircraft having an APU compartment on its rear end, in which at least one firewall includes the fireproof and thermal insulator product of the invention.

FIG. 5b shows a detailed view of the APU compartment.

FIGS. 6a and 6b respectively show a front firewall of an APU compartment.

FIG. 7 shows an engine deck for a helicopter comprising the fireproof and thermal insulator product of the invention.

FIG. 8 shows a helicopter engine compartment having a central wall comprising the fireproof and thermal insulator product of the invention.

### DETAILED DESCRIPTION OF THE INVENTION

The invention comprises a fireproof and thermal insulator product that prevents reaching high temperatures in the structural components around the fire source that could lead to its degradation. The product may serve for structural and non-structural applications.

It is important to take into account that the “fireproof” concept is defined by aeronautical regulations such as:

FAR/JAR 25.1191: Firewalls-Definition.

FAR/JAR 25.865: Fire Protection Of Flight Controls, Engine Mounts And Other Flight Structures.

According to the invention, the product comprises a honey-comb core infilled with Alkaline Earth Silicate (AES) material. The material of the honey-comb core can be metallic or polymeric.

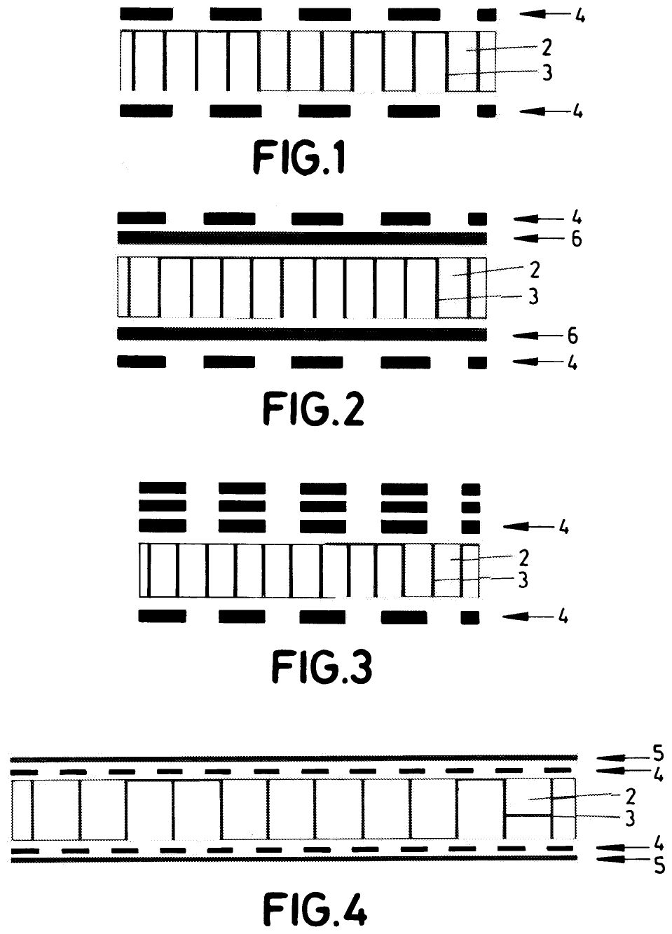

FIG. 1 shows a first preferred embodiment of the fireproof and thermal insulator product 1 of the invention that comprises a stack of layers including a honey-comb core 3 infilled with AES 2 surrounded by a pair of layers of FRP 4. Preferably, the layer of FRP 4 is a GFRP (Glass Fiber Reinforcement Plastic) layer.

FIG. 2 shows a second preferred embodiment of the fireproof and thermal insulator product 1 that additionally comprises an adhesive layer 6 deposited between the honey-comb core 3 infilled with AES 2 and the FRP layer 4.

The product may serve for structural and non-structural applications.

FIG. 3 shows a third preferred embodiment of the fireproof and thermal insulator product 1 that can be used for structural applications, that comprises a stack of layers including the honey-comb core 3 infilled with AES 2 surrounded by layers of FRP 4, at least one layer of FRP 4 at the bottom, and several layers on the top of the product 1.

In case of need, the infilled honey-comb core 3 may be protected against aggressive fluids, by covering the infilled core 3 with a liquid barrier film 5. This barrier may preferably be a thermoplastic film, such as a PVF (Poly-Vinyl Fluoride) film, a PEEK film, a PDVF film, or a PET film FIG. 4 shows an embodiment of this case, preferably used for non-structural applications.

As the product of the invention is more rigid than the state of the art solution with thermal blankets, it overcomes the limitation of their structural integration in composite parts. For example, the collapse of the insulator material during the curing in the autoclave due to the high pressure exerted.

The new solution comprising infilled honey-comb cores with AES have been tested fulfilling the FAR/JAR 25 regulations regarding firewalls, FAR/JAR25.1191 & FAR/JAR25.865, that is:
Direct flame impingement for 15 min.
Calibrated Flame of 1100° C. at a distance of 100 mm from the specimen.
Calibrated Heat Flux.
Specimen under vibration of 50 Hz (reduced to 16.6 Hz after 5 min.).
No load applied.
Protection against fluids of GFRP and PVF covering the infilled core.

According to another aspect, the invention also refers to a composite part that comprises the fireproof and thermal insulator product of the invention.

The product may be attached to the part by means of fasteners, and preferably by washers mounted creating an air chamber between the part and the product. Alternatively, the product is bonded to the part by means of an adhesive film, a paste adhesive or a click-bond. And alternatively, the product is integrated into the part by means of co-curing, co-bonding, or secondary-bonding.

Hereafter is a list of potential embodiments of the proposed invention:

Firewall of the Rear End of an Aircraft:

Sizing constraint: Fire-proof and Thermal protection
Modification: Replace current Titanium firewall by a new protection based in the proposed solution. Honeycomb core could be bent to be adapted for the corners and curved panels.
Benefits: Safety improvement, RC reduction, in case of fire, neither flame nor heat will affect the structure of the rear end of the aircraft, so there will be no need to replace it after fire event.

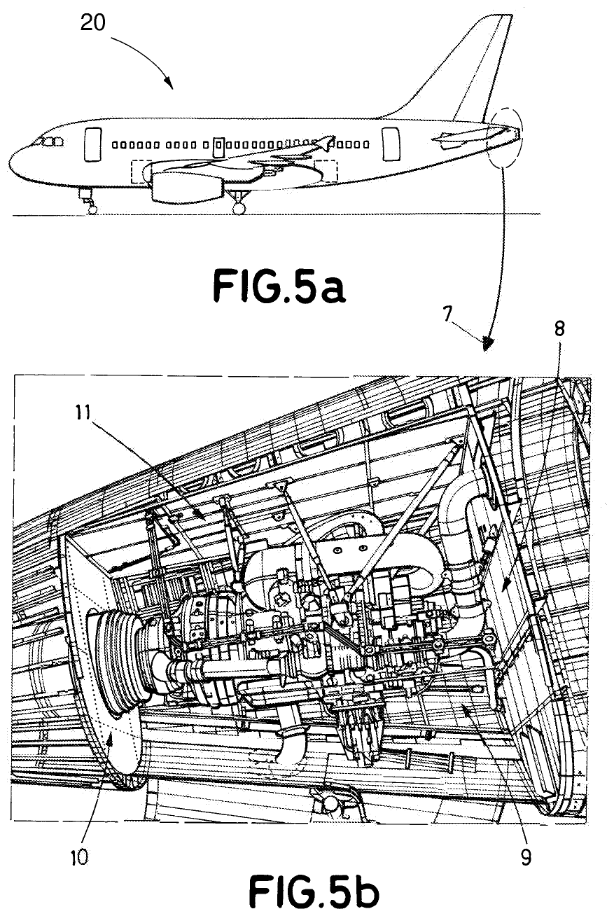

According to another aspect, the invention also refers to a rear end of an aircraft 20, comprising an APU compartment 7 insulated by at least one firewall 8, 9, 10, 11 that comprises the fireproof and thermal insulator product 1. FIG. 5a shows an aircraft 20 having an APU compartment 7 on its rear end. FIG. 5b shows a detailed view of the APU compartment 7 and most of its walls: the front firewall 8, the lateral firewall 9, the rear firewall 10, and the upper firewall 11, in where at least one of its walls includes the fireproof and thermal insulator product 1.

Front Firewall of the Rear End of an Aircraft:

Sizing constraint: Fire-proof and Thermal protection
Modification: Replace current Titanium firewall and aluminum stringers by a new protection based in the proposed solutions.
Benefits: Safety improvement, RC reduction, in case of fire, neither flame nor heat will affect the structure of the firewall, so there will be no need to replace it after fire event.

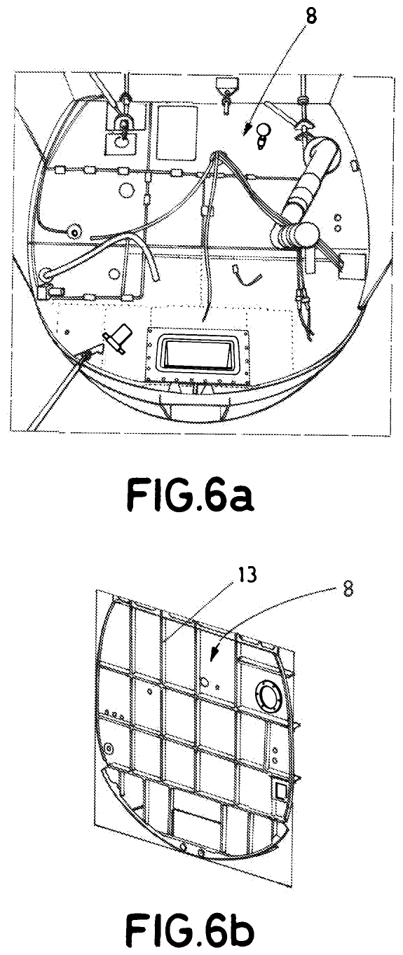

According to another aspect, the invention also refers to a front firewall 8 that comprises the fireproof and thermal insulator product 1. FIGS. 6a and 6b show a front firewall 8 of an APU compartment. FIG. 6b shows the stringers 13 that can be replaced by the proposed invention.

Composite Fireproof Duct:

Sizing constraint: Thermal protection

Modification: Replace current titanium, steel or Inconel ducts by composite ones based in the proposed solution.

Benefits: Safety improvement, RC reduction.

According to another aspect, the invention also refers to a duct comprising the fireproof and thermal insulator product 1.

Helicopter Engine Deck:

Sizing constraint: primary structure, thermal protection

Modification: Replace current Titanium skin and stringers by a composite sandwich with integrated fire & thermal protection.

Benefits: Weight saving by enabling a CFRP composite engine deck design, no mismatch of thermal expansion coefficient between engine deck and CFRP composite airframe

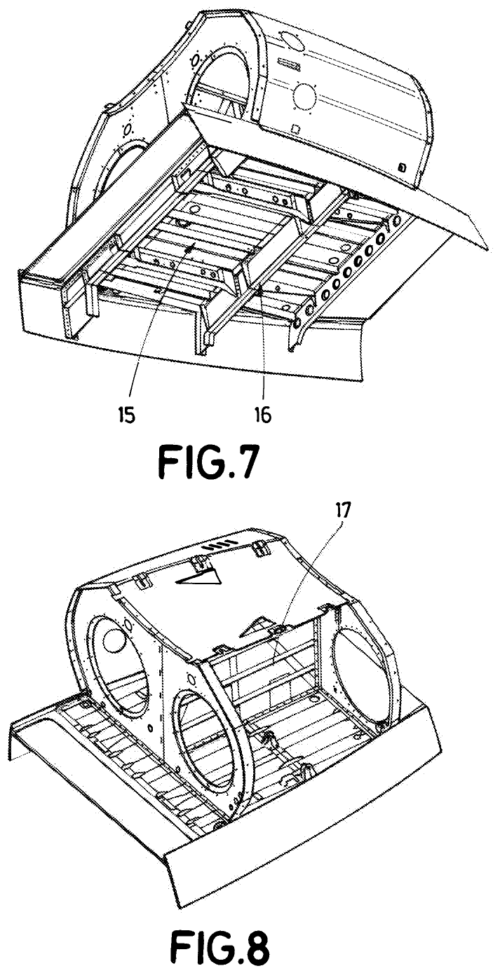

According to another aspect, the invention also refers to a helicopter engine deck 15 that comprises the fireproof and thermal insulator product 1. FIG. 7 shows an engine deck 15 including a titanium skin, stringers, clips and gussets, over a framework 16 usually made of aluminum.

Helicopter Engine Compartment Central Firewall:

Sizing constraint: stiffened panel, Thermal protection

Modification: Replace current stiffened Titanium skin by a composite sandwich with integrated fire & thermal protection.

Benefits: less maintenance and repair, increased value for the customer

According to another aspect, the invention also refers to a helicopter having an engine compartment including a central firewall 17 that comprises the fireproof and thermal insulator product 1. FIG. 8 shows a helicopter engine compartment having a central wall 17 comprising the fireproof and thermal insulator product 1.

Although the present invention has been fully described in connection with preferred embodiments, it is evident that modifications may be introduced within the scope thereof, not considering this as limited by these embodiments, but by the contents of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fireproof and thermal insulator product, which comprises a honey-comb core infilled with Alkaline Earth Silicate material.

2. The fireproof and thermal insulator product according to claim 1, further comprising an FRP layer staked onto the honey-comb core infilled with AES material, the FRP layer.

3. The fireproof and thermal insulator product according to claim 2, wherein the FRP layer comprises a Glass Fiber Reinforcement Plastic layer.

4. The fireproof and thermal insulator product according to claim 2, further comprising an adhesive layer deposited between the honey-comb core infilled with AES and the FRP layer.

5. The fireproof and thermal insulator product according to claim 1, further comprising a liquid barrier film.

6. The fireproof and thermal insulator product according to claim 5, wherein the liquid barrier film comprises a thermoplastic film.

7. The fireproof and thermal insulator product according to claim 6, wherein the thermoplastic film comprises a Poly-Vinyl Fluoride film, a PEEK film, a PDVF film, or a PET film.

8. The fireproof and thermal insulator product according to claim 2, further comprising a liquid barrier film, wherein the liquid barrier film is deposited over the FRP layer, contacting said FRP layer to protect the product from fluids.

9. A composite part comprising the fireproof and thermal insulator product according to claim 1, wherein the product is attached to the part by means of fasteners.

10. The composite part according to claim 9, wherein the fasteners comprise washers mounted to create an air chamber between the part and the product.

11. A composite part comprising the fireproof and thermal insulator product according to claim 1, wherein the product is bonded to the part by means of an adhesive film, a paste adhesive or a click-bond.

12. A composite part comprising the fireproof and thermal insulator product according to claim 1, wherein the product is integrated into the part by means of co-curing, co-bonding, or secondary-bonding.

13. A rear end of an aircraft, comprising an APU compartment insulated by at least one firewall that comprises the fireproof and thermal insulator product according to claim 1.

14. A rear end of an aircraft, comprising an APU compartment having at least one front firewall that comprises the fireproof and thermal insulator product according to claim 1.

15. A duct comprising the fireproof and thermal insulator product according to claim 1.

16. A helicopter having an engine deck that comprises the fireproof and thermal insulator product according to claim 1.

17. A helicopter having an engine compartment including a central firewall that comprises the fireproof and thermal insulator product according to claim 1.
